(19) United States
(12) Patent Application Publication
(10) Pub. No.: US 2011/0219924 A1
(43) Pub. Date: Sep. 15, 2011

(54) Method for Efficient Order Change of a Corrugator Dry End Using Order Look Ahead

(75) Inventor: James A. Cummings, Phillips, WI (US)

(73) Assignee: Marquip, LLC, Phillips, WI (US)

(21) Appl. No.: 12/832,243

(22) Filed: Jul. 8, 2010

Related U.S. Application Data
(60) Provisional application No. 61/224,554, filed on Jul. 10, 2009.

(51) Int. Cl. B26D 7/26

(52) U.S. Cl. 83/39

(57) ABSTRACT

The present invention provides a method for facilitating efficient order change in the dry end conversion of a corrugated paperboard web by looking ahead to as many as three orders scheduled to follow the running order and repositioning slit tools and score tools to unused positions in anticipation of the orders to follow. The method is particularly effective to preset the slit and score tools for an order that follows a short order that may have a running time as short as 20 seconds.

### CROSS REFERENCE TO RELATED APPLICATION

This application relates to and claims priority from U.S. Provisional Application Ser. No. 61/224,554 filed on Jul. 10, 2009.

### BACKGROUND

The present invention pertains to an approach to facilitating an efficient order change in the dry end conversion of a corrugated paperboard web.

In a corrugator dry end, the corrugated paperboard web is longitudinally scored and slit into multiple parallel out put webs (or “outs”). The outs are directed through one or more downstream cut-off knives which cut the output webs into selected sheet lengths. When two cut-off knives are used, they are vertically separated and each is capable of cutting the full corrugator width web. A web selector, positioned downstream of the slitter scorer divides the outs into two groups, one of which is directed to the upper cut-off knife and the other to the lower cut-off knife. Order changes must be effected while the upstream corrugator web end continues to product and deliver the continuous web to the slitter scorer. After an order change is completed, the slit and score tools must be repositioned or “set-up” for the next order. The time required for the set-up is a critical parameter related to the minimum length of order that can be run for a certain class of slitter scorers.

Prior art has developed two basic slitter scorer configurations. FIG. 1 shows a single station slitter scorer in a corrugator dry end line. With this concept, an order change is implemented by first totally laterally severing the web 5 with a rotary shear 10 with the dry end and upstream corrugator (not shown) slowed to some order change speed. A gap 15 is then pulled between the severed web 5 and the tailing out web 40 by accelerating the downstream slitter 20 and downstream knife(s) 30. As the tail of the web 40 clears the slitter scorer 20, the slit tools 21 and score tools 22 can be repositioned very quickly in the resulting gap between the new and old orders by use of individual motors (not shown) that control each slit and score head. These individual motors can either be attached directly to each slit and score head, or can power lead screws that drive each head individually. Alternatively, the individual slit and score heads can latch on/off turning lead screws to reach their respective head positions for the next order.

With this type of single station slitter scorer, the minimum order length can be very short because the individual head motors can be reprogrammed in a control sense to effectuate another head move with very short time delay. The speed at which order changes can be made is restricted by the time that it takes to move the heads from a current running position to the new running position in the gap 15. The order change speed is a function also of the gap pulling space, and the acceleration rate of the knife 30 controlling the tailout web 40. For reasonable gap pulling speeds and knife accelerations, order change speeds on single station slitter scorers of the type shown in FIG. 1 are well below the maximum corrugator speed.

For this and other reasons, the dual station slitter scorer of FIG. 2 was developed. With this dual station slitter scorer, station 101a could be set-up, while running station 101b, with use of individual head motors to adjust without laterally severing the web and creating a gap. By plunging the tools of the station set-up for the new order into an order change zone in the web while simultaneously lifting the tools running the current order from the web, order change could be made at very high speed. In addition, it was made possible to order change without interruption of the running webs to both levels of the cutoff knife, as defined by approaches shown in U.S. Pat. No. 6,092,452, U.S. Pat. No. 5,496,431, and U.S. Pat. No. 6,117,381. Although it would be possible to utilize individual head motors to position all of the heads on both stations of the dual station slitter scorer, in practice the use of a robot or robots was adapted to this purpose for reasons of reduced electrical complexity.

One embodiment of the dual station design is shown in FIG. 3. In this configuration, a single robot 25 is used to set up all of the heads of the dual station slitter scorer. This machine enjoys the benefit of reduced electrical complexity, but suffers from an increase in recovery time after an order change. The recovery time is a function of how many heads have to be relocated by the robot after order change from one of the stations.

Another embodiment of the dual station slitter is shown in FIG. 4. With this design, multiple robots 35 are used to independently set up the top and bottom score heads 22 on the score axes and the top slit heads 23 and bottom anvils 24 in the slit axes. The use of multiple robots reduces recovery time, but may still require substantial tool set-up time making the minimum order length unacceptably long.

### SUMMARY OF THE INVENTION

The invention relates to a method of using order look ahead and analysis to achieve dry end order change that is very efficient in terms of minimizing recovery time after an order change as well as minimizing waste associated with an order change. In accordance with the present invention, a quick recovery of a slitter scorer is accomplished by use of an automatic auxiliary (or second) score axis on one or both stations of the slitter scorer and the use of order look ahead to partially set up the slit tools and fully setting up the score tools on the unused automatic auxiliary score axis on the station running a current order.

### BRIEF DESCRIPTION OF THE DRAWINGS

FIG. 1 is a largely schematic side elevation view of a corrugator dry end showing one prior art single station slitter scorer.

FIG. 2 is a side elevation view similar to FIG. 1 of a prior art dual station slitter scorer positioned in a schematically shown corrugator dry end.

FIG. 3 is a side elevation view of one embodiment of a dual station slitter scorer using a single robot to set up all of the slit heads and score heads.

FIG. 4 is a further embodiment of a prior art dual station slitter utilizing multiple robots to facilitate more efficient slit and score head set up.

FIG. 5 is a schematic side elevation view of a corrugator dry end showing the presently preferred embodiment of the present invention.

FIG. 6 is a chart showing the sequence of order changes utilizing the method of the present invention.

FIG. 7 is a chart similar to FIG. 6 showing a special case of order change sequence when running in order having close score spacing requirements.

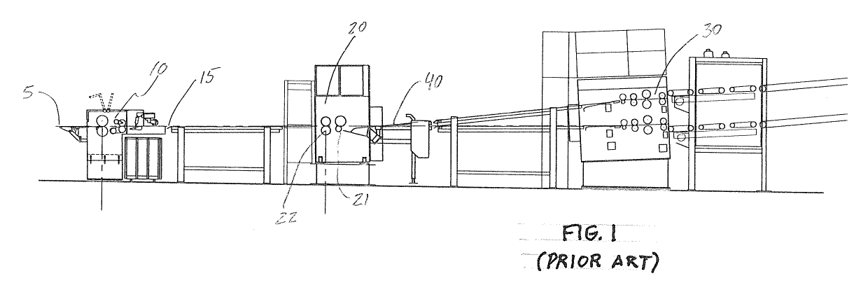

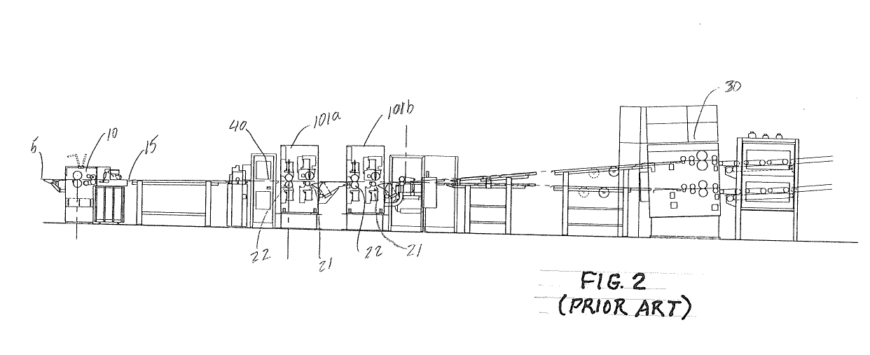

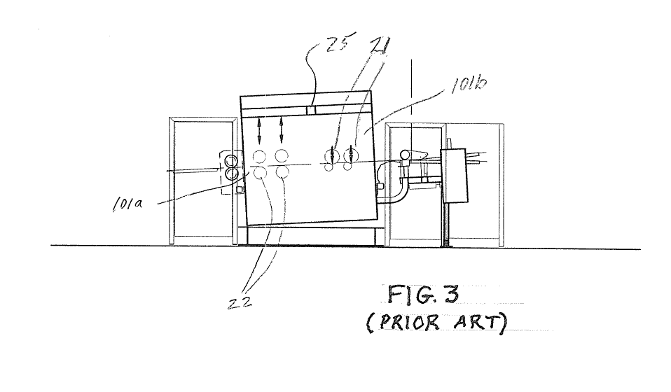

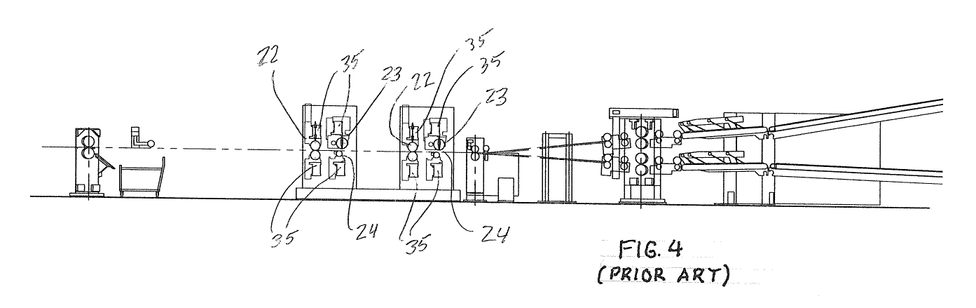

### DETAILED DESCRIPTION OF THE PREFERRED EMBODIMENT

Assume the current running order is positioned in the order queue immediately preceding a short order. This short order necessitates quick recovery after order change from the currently running slitter scorer station to a slit/score head position required for the order after the short order. To achieve this, non-used slit tools on the station associated with the current running order are set up at the positions associated with the order after the short order, to the extent they can be, consistent with not interfering in position with the currently running slit heads. The score tools on the unused auto auxiliary axis of the station running the current order are set up for the order after the next (short) order. Lastly, the quick recovery approach will utilize, to the extent possible with the working web width, asymmetric trim so that the trim slit head on one side of the currently running slitter will remain in its currently running position to accomplish the set-up for the order following the short order. This will eliminate the requirement of the robot to reposition this slit tool in the order setup process and thereby substantially reduce the recovery time.

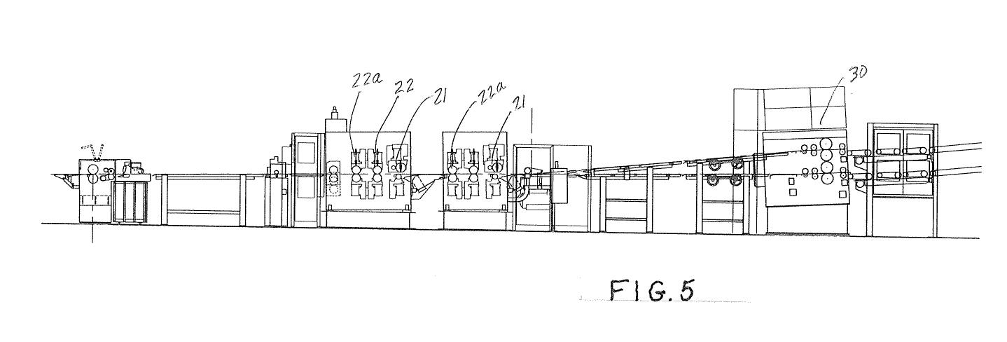

In accordance with the present invention, a quick recovery of a slitter scorer is accomplished on a slitter with one or more redundant score axes. The dual station slitter concept requires a minimum of one slit axis 21 and one score axis 22 for each station. Automatic auxiliary score axes 22a are added to one or both stations of the slitter scorer, as shown in FIG. 5. The score tooling associated with auxiliary score axis 22a can be set up using a robot that is shared between nominal score axis 22 and the auxiliary score axis 22a. The shared robot can be used to set up score axis 22 or auxiliary score axis 22a, but not both simultaneously. The present invention uses an order look ahead approach to set up for a future order on an unused auxiliary score axis 22a of a station running a current order. This order look ahead is further used to set up the unused station for the next order to be run on the score axis 22 as well as set up of yet another future order on the automatic auxiliary score axis 22a of this unused station.

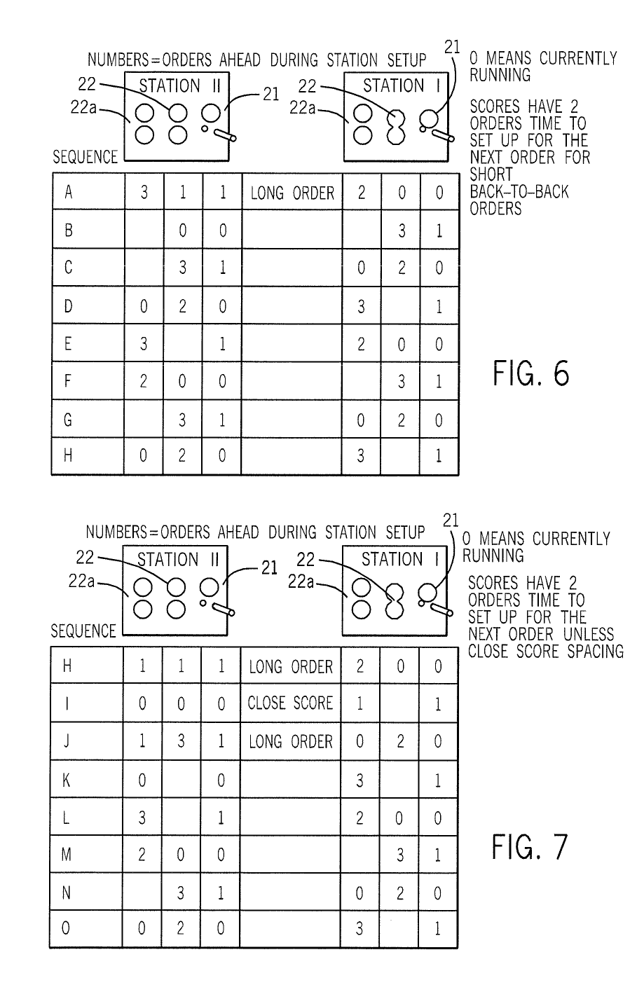

A typical sequence of orders using the present invention is shown in FIG. 6. In FIG. 6, order “0” is the current running order and orders “1”, “2” and “3” are the next orders in the schedule. The sequence of order set-ups on the slitter stations is designated by capital letters A-H. Assume for purposes of description that the current running order (order “0”) in sequence A is a longer running order that is set up on the slit axis 21 and the first score axis 22 of Station I as shown in FIG. 6. Slitter set up sequencing would then have the slit axis and first score axis of Station II set up to run the next order in the schedule (order “1”). In accordance with the present invention, the scores associated with the second order after the running order (order “2”) would be set up on the unused score axis 22a of running Station I, and the scores associated with the third order after the running order (order “3”) would be set up on the auxiliary score axis 22a of Station II as shown for Sequence A of FIG. 6.

At the end of order “0” in Sequence A, an order change occurs to Sequence B of FIG. 6. The scores for the next order (order “1”) on Sequence B were already set up on the upstream auxiliary score axis 22a of Station I. The slits for order “1” must be set up on Station I, using concepts related to order look ahead that will be covered below.

Immediately after order change to Sequence B, the first score axis 22 of Station I will begin to be set up for the third order after (order “3”) after the running the order on Station II. The unused score axis 22a on Station II had previously been set up for the third order after the running order of Sequence A. This setup is now for the second order after the running order of Sequence B.

The Sequence B short order on Station II completes transitioning to Sequence C, also a short order. In Sequence C, the current order “0” runs on Station I and the setup continues on the unused score axis 22 of Station I for the second order after the Sequence C running order. The setup is completed while running the short order of Sequence C. On Station II, the robot begins to set up for the order three ahead on the unused score axis 22.

To continue the analysis of FIG. 6, the next order change to Sequence D results in the running order “0” to be on Station II. On the unused score axis 22 on Station II, set up continues for the order two after the order now running on Station II and is complete at the end of Sequence D. This axis had the time available for set up while running Sequence C and Sequence D. It should be clear now that the order look ahead concept of the present invention will allow set up of scores on any axis to be completed during the running of the two previous orders.

With the other look-ahead concept of the current invention, it would be possible to halve the required recovery time of the slitter for efficient running of short orders. For example, all the orders from Sequence B onward could be 20 second back-to-back orders if score head placement times for all orders were less than 40 seconds.

On the slit head recovery, orders from each alternate sequence must be run on a given station, so slit head recovery must occur within the duration of the run of a short order. A critical aspect of the current invention regarding slit head placement is that unused slit heads are set up between running positions of other slit heads, on the same axis, consistent with physical aspects of head interference. Yet, a second critical aspect of slit head recovery is that the trim slit head on one side of the machine stays engaged in its current running position during an order change with asymmetric trim after the order change. This will be possible as long as the resulting trim width adjustment on the opposite trim slit head is not less than the minimum slit width that can be run on the slitter. Since there are half as many slit heads as score heads, it is likely that the combinations of pre-positioning unused slit heads and taking asymmetric trim will allow quick slit head recovery. All move distances for slit heads will be very short as only physical interference of heads will preclude pre-position.

There are times when both score axes must be used to run an order due to close score spacing requirements. This situation is shown in FIG. 7 in Sequence I on Station II. When running this close score spacing order (that requires the use of both score axes 22 and 22a), the next running order on Station I, as shown in Sequence J, must be longer, allowing set up of both of the score axes on Station II for the orders one and three ahead.

I claim:

1. In a corrugator for forming a paperboard web and converting the web into paperboard sheets by directing the formed web through a slitter/scorer apparatus and a cut-off knife apparatus, a method for minimizing order change recovery time for repositioning slitter tools and scorer tools for scheduled orders of varying lengths, the method comprising the steps of:
(1) providing two slitter/scorer stations, each having a slit axis carrying a plurality of laterally positionable slit tools and a score axis carrying a plurality of laterally positionable score tools;
(2) providing a first of said stations with an auxiliary score axis carrying a plurality of laterally positionable score tools;
(3) while running a current order on the first station, positioning the score tools and the slit tools associated with the first order scheduled to follow the running order on the respective slit and score axes of the second station;
(4) while running the current order, positioning unused slit tools on the first station at positions associated with the second order scheduled to follow the running order, consistent with avoiding interference with currently running slit tools;
(5) positioning unused score tools on the auxiliary axis of the first station running the current order for the second order following the running order;
(6) in an order change region of the web, plunging the slit tools and score tools for the first order following the current running order into the web; and,
(7) withdrawing the slit tools and score tools for the current running order from the web and repositioning withdrawn slit tools, as needed, for the second order following the current running order.

2. The method as set forth in claim 1 including the steps of:
(1) providing the second station with an auxiliary score axis carrying a plurality of laterally positionable score tools; and,
(2) positioning the score tools associated with the third order after the running order on the auxiliary score axis of the second station.

3. The method as set forth in claim 1 including the steps of:
(1) providing the slit axis of each station with laterally positionable trim slit tools on opposite ends; and,
(2) retaining the position of the trim slit tool on one end of the station running the current order during order change to provide asymmetric trim and eliminate the need to reposition said trim slit tool at order change.

4. In a corrugator for forming a paperboard web and converting the web into paperboard sheets by directing the formed web through a slitter/scorer apparatus and a cut-off knife apparatus, a method for minimizing order change recovery time for repositioning slit tools and score tools for an order scheduled to follow a minimum length order, the method comprising the steps of:
(1) providing two slitter/scorer stations, each having a slit axis carrying a plurality of laterally positionable slit tools and two score axes each carrying a plurality of laterally positionable score tools;
(2) while running a current order on the first station, positioning the score tools and the slit tools associated with a first following minimum length order on one of the score axes and slit axis of the second station;
(3) while running the current order, positioning unused slit tools on the first station at positions associated with the second order scheduled to follow the running order, consistent with avoiding interference with currently running slit tools;
(4) positioning the unused score tools on the other score axis of the first station running the current order for the second order following the running order;
(5) positioning the score tools associated with the third order after the running order on the other score axis of the second station;
(6) in an order change region of the web, plunging the slit tools and score tools for the first following minimum length order into the web; and,
(7) withdrawing the slit tools and score tools for the running order from the web and repositioning withdrawn slit tools, as needed, for the third order following the running order.

5. The method as set forth in claim 4 including the steps of:
(1) providing the slit axis of each station with laterally positionable trim slit tools on opposite ends; and,
(2) retaining the position of the trim slit tool on one end of the station running the current order during order change to provide asymmetric trim and eliminate the need to reposition said trim slit tool at order change.

6. In a corrugator for forming a paperboard web and converting the web into paperboard sheets by directing the formed web through a slitter/scorer apparatus and a cut-off knife apparatus, the corrugator including a system for scheduling serial orders, the completion of a currently running order being followed by an order requiring repositioning of the slit and score tools, a method for minimizing order change recovery time for repositioning slit tools and score tools for an order scheduled to follow a minimum length order, the method comprising the steps of:
(1) providing two slitter/scorer stations, each having a slit axis carrying a plurality of laterally positionable slit tools and two score axes each carrying a plurality of laterally positionable score tools;
(2) while running a current order on the first station, positioning the sore tools and the slit tools associated with a first following minimum length order on one of the score axes and slit axis of the second station;
(3) while running the current order, positioning unused slit tools and score tools on the first and second stations at positions associated with the second and third orders scheduled to follow the running order, consistent with avoiding interference with currently running slit tools;
whereby the positioning of unused slit tools and score tools in consistent with the running order and each subsequent serial order is run on alternate stations.
